(19) United States
(12) Patent Application Publication
(10) Pub. No.: US 2008/0299673 A1
(43) Pub. Date: Dec. 4, 2008

(54) Method for Employing a Biosensor to Detect Small Molecules ("Fragments") that Bind Directly to Immobilized Protein Targets

(75) Inventors: Rick Wagner, Cambridge, MA (US); Lance Laing, Belmont, MA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: SRU Biosystems, Inc.

(21) Appl. No.: 12/106,283

(22) Filed: Apr. 19, 2008

Related U.S. Application Data
(60) Provisional application No. 60/912,725, filed on Apr. 19, 2007.

(51) Int. Cl. G01N 21/62

(52) U.S. Cl. 436/171

(57) ABSTRACT

The invention provides method of detecting interactions of small molecules with target molecules.

### PRIORITY

This application claims the benefit of U.S. Pat. No. 60/912,725, filed on Apr. 19, 2007, which is incorporated herein by reference in its entirety.

### BACKGROUND OF THE INVENTION

Identification of high quality lead compounds for druggable protein targets is a complex task. It can be difficult to generate leads that are novel and optimizable. Recently, fragment-based screening has been explored as a method of generating high quality leads. It appears that compounds with a molecular weight of about 100 Da to about 300 Da (i.e., “fragments”) may provide better leads than compounds with a molecular weight of about 300 Da to about 600 Da, which have historically been used for lead generation. Although fragments are often weakly binding molecules, screening for weakly binding molecules of low molecular weight that bind to therapeutic target proteins is useful to determine small building blocks that can be chemically combined to provide tighter binding compounds of slightly higher molecular weight. These molecules may then have a therapeutic effect against the target protein. Even though low molecular weight compounds can lead to development of efficacious drugs, identification of weak binding, very low molecular weight compounds is extremely slow and difficult. Prior methods of finding any sized compounds that bind to proteins or target molecules have involved methods that require the compounds to bind with a certain energy not usually attained by fragment compounds. Prior identification methods for identifying fragment compounds that bind to proteins involve considerable amounts of protein, are labor intensive, require expensive instrumentation operated by highly educated individuals, and take many days or weeks to screen a few small compounds. The typical methods employ classical biophysical techniques such as multi-dimensional nuclear magnetic resonance spectroscopy (NMR), x-ray crystallography, or isothermal titration calorimetry. Methods for screening fragment-based compound libraries of about 100 Da to about 300 Da in a high throughput manner that use small quantities of the test compounds are needed in the art.

### SUMMARY OF THE INVENTION

In one embodiment the invention provides a method of determining the affinity of small molecules for target molecules. The method comprises immobilizing the target molecules to a surface of a calorimetric resonant reflectance biosensor and determining a first peak wavelength value. Small molecules are added to the surface of the calorimetric resonant reflectance biosensor at 3 or more different concentrations and a peak wavelength value is determined at the 3 or more different concentrations. The peak wavelengths are compared to determine the affinity of the small molecules for the target molecules. The small molecules can be less than about 300 Da. The dissociation constant (Kd) of the small molecules can be determined. The dissociation constant of the small molecules can be about 2,000, to about 750 μM. The concentration of the small molecules can be about 0.5 mM to about 0.01 mM.

In another embodiment the invention provides a method of determining a rank affinity of a small molecule sample. The method comprises detecting a first peak wavelength value of a surface of a calorimetric resonant reflectance biosensor. Target molecules with a known molecular weight are immobilized to the surface of the calorimetric resonant reflectance biosensor and a second peak wavelength value is determined. The amount of moles of the target molecule that is bound to the calorimetric resonant reflectance biosensor is determined using the first and second peak wavelength values. A specific concentration of a small molecule sample with a known molecular weight is added to the calorimetric resonant reflectance biosensor and a third peak wavelength value is determined. The difference between the second peak wavelength value and the third peak wavelength value provides the amount of small molecule bound to the calorimetric resonant reflectance biosensor surface. The rank affinity of the small molecule sample is determined using ratio of the difference between the first peak wavelength value and the second peak wavelength value to the difference between the second peak wavelength value and the third peak wavelength value. The small molecule sample can comprises small molecules that are less than about 300 Da. The dissociation constant of the small molecules in the small molecule sample can be about 2,000, to about 750 μM. The concentration of the small molecules in the small molecule sample can be about 0.5 mM to about 0.01 mM.

Still another embodiment of the invention provides a method of determining if small molecules bind to a specific site on a target molecule or compete for target binding with a known blocker of a target site on the target molecule. The method comprises immobilizing the target molecule to a first calorimetric resonant reflectance biosensor. The target molecule is immobilized to a second calorimetric resonant reflectance biosensor, wherein the target site of the target molecule is blocked with a known blocker of the target site. Small molecules are added to both the first and second calorimetric resonant reflectance biosensors and peak wavelength values are determined for the first and second calorimetric resonant reflectance biosensors. If the peak wavelength value of the first calorimetric resonant reflectance biosensor is shifted as compared to the peak wavelength value of the second calorimetric resonant reflectance biosensor, then the small molecules compete with the known blocker of a target site on the target molecule or binds to a specific site on the target molecule. The small molecules can be less than about 300 Da. The dissociation constant of the small molecules can be about 2,000, to about 750 μM. The concentration of the small molecules can be about 0.5 mM to about 0.01 mM.

Even another embodiment of the invention provides a method of determining if small molecules of less than 300 Da bind to target molecules. The method comprises immobilizing the target molecules to a surface of a colorimetric resonant reflectance biosensor and determining a first peak wavelength value. The small molecules are added to the surface of the calorimetric resonant reflectance biosensor and a second peak wavelength value is determined. The first and second peak wavelengths are compared, wherein if the second peak wavelength value is shifted as compared to the first peak wavelength value, then the small molecules bind the target molecules. The dissociation constant (Kd) of the small molecules can be determined. The dissociation constant of the small molecules can be about 2,000, to about 750 μM. The concentration of the small molecules can be about 0.5 mM to about 0.01 mM.

Therefore, the invention provides for the determination of very low molecular weight compounds, known to one familiar with the art as fragments, binding to target biomolecules. The invention provides the rigorousness of typical biochemical tests for quantifying and qualifying the interaction as well as providing for the determination of other properties of the fragment molecule. The methods are much more economical, requiring far less time for the determination and requiring much less reagent than one typically finds employed for the same determination using traditional methods such as NMR spectroscopy, x-ray crystallography, or calorimetry.

### BRIEF DESCRIPTION OF THE DRAWINGS

FIG. 1 shows the reproducibility of the biosensor for sensitive detection of weakly associating small molecules to a target surface.

FIG. 2 shows aggregating compounds and DMSO mismatch compounds provide a significantly different signal on the control or blocked surface (x-axis) as compared to the target surface (y-axis) when added in equal concentrations to both.

FIG. 3 shows that the methods of the invention can be used to titrate and obtain reasonable affinity binding curves for known binding compounds obtained by other biophysical methods.

FIG. 4 demonstrates methods of this invention enable the determination of binding of weakly associating fragments to different binding sites.

FIG. 5 shows a time course assay of binding for specificity determination.

### DETAILED DESCRIPTION OF THE INVENTION

One embodiment of the invention allows the direct detection of binding of small molecule (also know as fragments) to target molecule with a biosensor, e.g., a calorimetric resonant reflectance biosensor, without the need to incorporate radiometric, calorimetric, or fluorescent labels, even where the binding interaction is very weak. The binding can be detected in real time using a high speed, high resolution instrument, such as the BIND Scanner™ (i.e., a calorimetric resonant reflectance biosensor system), and corresponding algorithms to quantify data. See, e.g., U.S. Pat. No. 6,951,715 and U.S. Pat. Publ. 2004/0151626. By combining this methodology, instrumentation and computational analyses, binding of small molecules to a target molecule can be expediently monitored in real time, in a label free manner even where the binding is very weak.

### Biosensors

Biosensors of the invention can be calorimetric resonant reflectance biosensors. See e.g., Cunningham et al., “Colorimetric resonant reflection as a direct biochemical assay technique,” Sensors and Actuators B, Volume 81, p. 316-328, Jan. 5 2002; U.S. Pat. Publ. No. 2004/0091397. Colorimetric resonant biosensors are not surface plasmon resonant (SPR) biosensors. SPR biosensors have a thin metal layer, such as silver, gold, copper, aluminum, sodium, and indium. The metal must have conduction band electrons capable of resonating with light at a suitable wavelength. A SPR biosensor surface exposed to light must be pure metal. Oxides, sulfides and other films interfere with SPR. Colorimetric resonant biosensors do not have a metal layer, rather they have a dielectric coating of high refractive index material, such as TiO₂.

Grating-based waveguide biosensors are described in, e.g., U.S. Pat. No. 5,738,825. A grating-based waveguide biosensor comprises a waveguiding film and a diffraction grating that incouples an incident light field into the waveguiding film to generate a diffracted light field. A change in the effective refractive index of the waveguiding film is detected. Devices where the wave must be transported a significant distance within the device, such as grating-based waveguide biosensors, lack the spatial resolution of the current invention.

A calorimetric resonant reflectance biosensor allows biochemical interactions to be measured on the biosensor's surface without the use of fluorescent tags, calorimetric labels or any other type of detection tag or detection label. A biosensor surface contains an optical structure that, when illuminated with collimated and/or white light, is designed to reflect only a narrow band of wavelengths (“a resonant grating effect”). The narrow wavelength band is described as a wavelength “peak.” The “peak wavelength value” (PWV) changes when materials, such as biological materials, are deposited or removed from the biosensor surface. A readout instrument is used to illuminate distinct locations on a biosensor surface with collimated and/or white light, and to collect reflected light. The collected light is gathered into a wavelength spectrometer for determination of a PWV.

A biosensor can be incorporated into standard disposable laboratory items such as microtiter plates by bonding the structure (biosensor side up) into the bottom of a bottomless microtiter plate cartridge. Incorporation of a biosensor into common laboratory format cartridges is desirable for compatibility with existing microtiter plate handling equipment such as mixers, incubators, and liquid dispensing equipment. Colorimetric resonant reflectance biosensors can also be incorporated into, e.g., microfluidic, macrofluidic, or microarray devices (see, e.g., U.S. Pat. No. 7,033,819, U.S. Pat. No. 7,033,821). Colorimetric resonant reflectance biosensors can be used with well-know methodology in the art (see, e.g., Methods of Molecular Biology edited by Jun-Lin Guan, Vol. 294, Humana Press, Totowa, N.J.) to monitor covalent or non-covalent binding of molecules to the surface of the biosensor.

Colorimetric resonant reflectance biosensors comprise subwavelength structured surfaces (SWS) and are an unconventional type of diffractive optic that can mimic the effect of thin-film coatings. (Peng & Morris, “Resonant scattering from two-dimensional gratings,” J. Opt. Soc. Am. A, Vol. 13, No. 5, p. 993, May 1996; Magnusson, & Wang, “New principle for optical filters,” Appl. Phys. Lett., 61, No. 9, p. 1022, August, 1992; Peng & Morris, “Experimental demonstration of resonant anomalies in diffraction from two-dimensional gratings,” Optics Letters, Vol. 21, No. 8, p. 549, April, 1996). A SWS structure contains a one-dimensional, two-dimensional, or three dimensional grating in which the grating period is small compared to the wavelength of incident light so that no diffractive orders other than the reflected and transmitted zeroth orders are allowed to propagate. Propagation of guided modes in the lateral direction are not supported. Rather, the guided mode resonant effect occurs over a highly localized region of approximately 3 microns from the point that any photon enters the biosensor structure.

The reflected or transmitted light of a calorimetric resonant reflectance biosensor can be modulated by the addition of molecules such as specific binding substances, target molecules or small molecules or a combination thereof to the upper surface of the biosensor. The added molecules increase the optical path length of incident radiation through the structure, and thus modify the wavelength at which maximum reflectance or transmittance will occur.

In one embodiment, a calorimetric resonant reflectance biosensor, when illuminated with white and/or collimated light, is designed to reflect a single wavelength or a narrow band of wavelengths (a “resonant grating effect”). When mass is deposited on the surface of the biosensor, the reflected wavelength is shifted due to the change of the optical path of light that is shown on the biosensor.

A detection system consists of, for example, a light source that illuminates a small spot of a biosensor at normal incidence through, for example, a fiber optic probe, and a spectrometer that collects the reflected light through, for example, a second fiber optic probe also at normal incidence. Because no physical contact occurs between the excitation/detection system and the biosensor surface, no special coupling prisms are required and the biosensor can be easily adapted to any commonly used assay platform including, for example, microtiter plates. A single spectrometer reading can be performed in several milliseconds, thus it is possible to quickly measure a large number of molecular interactions taking place in parallel upon a biosensor surface, and to monitor reaction kinetics in real time.

Layer thicknesses (i.e. cover layer, biological material, or an optical grating) are selected to achieve resonant wavelength sensitivity to additional molecules on the top surface. The grating period is selected to achieve resonance at a desired wavelength.

A colorimetric resonant reflectance biosensor comprises, e.g., an optical grating comprised of a high refractive index material, a substrate layer that supports the grating, and optionally one or more specific binding substances or linkers immobilized on the surface of the grating opposite of the substrate layer. The high refractive index material has a higher refractive index than a substrate layer. See, e.g., U.S. Pat. No. 7,094,595; U.S. Pat. No. 7,070,987. A substrate layer can be a polymer, plastic, glass or a nanoporous material. See U.S. Pat. Publ. 2007/0009380. Optionally, a cover layer covers the grating surface. An optical grating is coated with a high refractive index dielectric film which can be comprised of a material that includes, for example, zinc sulfide, titanium dioxide, tantalum oxide, silicon nitride, and silicon dioxide. A cross-sectional profile of a grating with optical features can comprise any periodically repeating function, for example, a “square-wave.” An optical grating can also comprise a repeating pattern of shapes selected from the group consisting of lines (one-dimensional), squares, circles, ellipses, triangles, trapezoids, sinusoidal waves, ovals, rectangles, and hexagons. A calorimetric resonant reflectance biosensor of the invention can also comprise an optical grating comprised of, for example, plastic or epoxy, which is coated with a high refractive index material.

Linear gratings (i.e., one dimensional gratings) have resonant characteristics where the illuminating light polarization is oriented perpendicular to the grating period. A calorimetric resonant reflection biosensor can also comprise, for example, a two-dimensional grating, e.g., a hexagonal array of holes or squares. Other shapes can be used as well. A linear grating has the same pitch (i.e. distance between regions of high and low refractive index), period, layer thicknesses, and material properties as a hexagonal array grating. However, light must be polarized perpendicular to the grating lines in order to be resonantly coupled into the optical structure. Therefore, a polarizing filter oriented with its polarization axis perpendicular to the linear grating must be inserted between the illumination source and the biosensor surface. Because only a small portion of the illuminating light source is correctly polarized, a longer integration time is required to collect an equivalent amount of resonantly reflected light compared to a hexagonal grating.

An optical grating can also comprise, for example, a “stepped” profile, in which high refractive index regions of a single, fixed height are embedded within a lower refractive index cover layer. The alternating regions of high and low refractive index provide an optical waveguide parallel to the top surface of the biosensor.

A calorimetric resonant reflectance biosensor of the invention can further comprise a cover layer on the surface of an optical grating opposite of a substrate layer. Where a cover layer is present, the one or more specific binding substances are immobilized on the surface of the cover layer opposite of the grating. Preferably, a cover layer comprises a material that has a lower refractive index than a material that comprises the grating. A cover layer can be comprised of, for example, glass (including spin-on glass (SOG)), epoxy, or plastic.

For example, various polymers that meet the refractive index requirement of a biosensor can be used for a cover layer. SOG can be used due to its favorable refractive index, ease of handling, and readiness of being activated with specific binding substances using the wealth of glass surface activation techniques. When the flatness of the biosensor surface is not an issue for a particular system setup, a grating structure of SiN/glass can directly be used as the sensing surface, the activation of which can be done using the same means as on a glass surface.

Resonant reflection can also be obtained without a planarizing cover layer over an optical grating. For example, a biosensor can contain only a substrate coated with a structured thin film layer of high refractive index material. Without the use of a planarizing cover layer, the surrounding medium (such as air or water) fills the grating. Therefore, specific binding substances are immobilized to the biosensor on all surfaces of an optical grating exposed to the specific binding substances, rather than only on an upper surface.

In general, a calorimetric resonant reflectance biosensor of the invention will be illuminated with white and/or collimated light that will contain light of every polarization angle. The orientation of the polarization angle with respect to repeating features in a biosensor grating will determine the resonance wavelength. For example, a “linear grating” (i.e., a one-dimensional grating) biosensor consisting of a set of repeating lines and spaces will have two optical polarizations that can generate separate resonant reflections. Light that is polarized perpendicularly to the lines is called “s-polarized,” while light that is polarized parallel to the lines is called “p-polarized.” Both the s and p components of incident light exist simultaneously in an unfiltered illumination beam, and each generates a separate resonant signal. A biosensor can generally be designed to optimize the properties of only one polarization (the s-polarization), and the non-optimized polarization is easily removed by a polarizing filter.

In order to remove the polarization dependence, so that every polarization angle generates the same resonant reflection spectra, an alternate biosensor structure can be used that consists of a set of concentric rings. In this structure, the difference between the inside diameter and the outside diameter of each concentric ring is equal to about one-half of a grating period. Each successive ring has an inside diameter that is about one grating period greater than the inside diameter of the previous ring. The concentric ring pattern extends to cover a single sensor location—such as an array spot or a microtiter plate well. Each separate microarray spot or microtiter plate well has a separate concentric ring pattern centered within it. All polarization directions of such a structure have the same cross-sectional profile. The concentric ring structure must be illuminated precisely on-center to preserve polarization independence. The grating period of a concentric ring structure is less than the wavelength of the resonantly reflected light. The grating period is about 0.01 micron to about 1 micron. The grating depth is about 0.01 to about 1 micron.

In another embodiment, an array of holes or posts are arranged to closely approximate the concentric circle structure described above without requiring the illumination beam to be centered upon any particular location of the grid. Such an array pattern is automatically generated by the optical interference of three laser beams incident on a surface from three directions at equal angles. In this pattern, the holes (or posts) are centered upon the corners of an array of closely packed hexagons. The holes or posts also occur in the center of each hexagon. Such a hexagonal grid of holes or posts has three polarization directions that “see” the same cross-sectional profile. The hexagonal grid structure, therefore, provides equivalent resonant reflection spectra using light of any polarization angle. Thus, no polarizing filter is required to remove unwanted reflected signal components. The period of the holes or posts can be about 0.01 microns to about 1 micron and the depth or height can be about 0.01 microns to about 1 micron.

A detection system can comprise a calorimetric resonant reflectance biosensor a light source that directs light to the calorimetric resonant reflectance biosensor, and a detector that detects light reflected from the biosensor. In one embodiment, it is possible to simplify the readout instrumentation by the application of a filter so that only positive results over a determined threshold trigger a detection.

By measuring the shift in resonant wavelength at each distinct location of a calorimetric resonant reflectance biosensor of the invention, it is possible to determine which distinct locations have, e.g., biological material deposited on them. The extent of the shift can be used to determine, e.g., the amount of binding partners in a test sample and the chemical affinity between one or more specific binding substances and the binding partners of the test sample.

A calorimetric resonant reflectance biosensor can be illuminated twice. The first measurement determines the reflectance spectra of one or more distinct locations of a biosensor with, e.g., no target molecules on the biosensor. The second measurement determines the reflectance spectra after, e.g., one or more molecules are applied to a biosensor. The difference in peak wavelength between these two measurements is a measurement of the presence or amount of molecules on the biosensor. This method of illumination can control for small imperfections in a surface of a biosensor that can result in regions with slight variations in the peak resonant wavelength. This method can also control for varying concentrations or density of molecules on a biosensor.

### Surface of Biosensor

One or more specific binding substances or target molecules can be immobilized on a biosensor by for example, physical adsorption or by chemical binding. A target molecule can specifically bind to a biosensor surface via a specific binding substance such as a nucleic acid, peptide, protein solution, peptide solution, solutions containing compounds from a combinatorial chemical library, antigen, polyclonal antibody, monoclonal antibody, single chain antibody (scFv), F(ab) fragment, F(ab′)₂ fragment, Fv fragment, small organic molecule, virus, polymer or biological sample, wherein the target molecule is immobilized to the surface of the biosensor. Target molecules can be non-covalently or covalently attached to the biosensor.

Target molecules can be arranged in an array of one or more distinct locations on the biosensor surface, said surface residing within one or more wells of a multiwell plate and comprising one or more surfaces of the multiwell plate or microarray. The array of target molecules comprises one or more target molecules on the biosensor surface within a microwell plate such that a surface contains one or more distinct locations, each with a different target molecule or with a different amount of target molecules. For example, an array can comprise 1, 10, 100, 1,000, 10,000 or 100,000 or greater distinct locations. Thus, each well of a multiwell plate or microarray can have within it an array of one or more distinct locations separate from the other wells of the multiwell plate, which allows multiple different samples to be processed on one multiwell plate. The array or arrays within any one well can be the same or different than the array or arrays found in any other microtiter wells of the same microtiter plate.

Immobilization of a target molecule to a biosensor surface can be also be affected via binding to, for example, the following functional linkers: a nickel group, an amine group, an aldehyde group, an acid group, an alkane group, an alkene group, an alkyne group, an aromatic group, an alcohol group, an ether group, a ketone group, an ester group, an amide group, an amino acid group, a nitro group, a nitrile group, a carbohydrate group, a thiol group, an organic phosphate group, a lipid group, a phospholipid group or a steroid group. Furthermore, a target molecule can be immobilized on the surface of a biosensor via physical adsorption, chemical binding, electrochemical binding, electrostatic binding, hydrophobic binding or hydrophilic binding, and immunocapture methods.

In one embodiment of the invention a biosensor can be coated with a linker such as, e.g., a nickel group, an amine group, an aldehyde group, an acid group, an alkane group, an alkene group, an alkyne group, an aromatic group, an alcohol group, an ether group, a ketone group, an ester group, an amide group, an amino acid group, a nitro group, a nitrile group, a carbohydrate group, a thiol group, an organic phosphate group, a lipid group, a phospholipid group or a steroid group. For example, an amine surface can be used to attach several types of linker molecules while an aldehyde surface can be used to bind proteins directly, without an additional linker. A nickel surface can be used to bind molecules that have an incorporated histidine (“his”) tag. Detection of “his-tagged” molecules with a nickel-activated surface is well known in the art (Whitesides, Anal Chem. 68, 490, (1996)).

Linkers and specific binding substances can be immobilized on the surface of a biosensor such that each well has the same linkers and/or specific binding substances immobilized therein. Alternatively, each well can contain a different combination of linkers and/or specific binding substances.

A target molecule can specifically or non-specifically bind to a linker or specific binding substance immobilized on the surface of a biosensor. Alternatively, the surface of the biosensor can have no linker or specific binding substance and a target molecule can bind to the biosensor surface non-specifically.

Immobilization of one or more specific binding substances or linker onto a biosensor is performed so that a specific binding substance or linker will not be washed away by rinsing procedures, and so that its binding to target molecules in a test sample is unimpeded by the biosensor surface. Several different types of surface chemistry strategies have been implemented for covalent attachment of specific binding substances to, for example, glass, plastic or nanoporous materials for use in various types of microarrays and biosensors. Surface preparation of a biosensor so that it contains the correct functional groups for binding one or more specific binding substances is an integral part of the biosensor manufacturing process.

One or more specific target molecules can be attached to a biosensor surface by physical adsorption (i.e., without the use of chemical linkers) or by chemical binding (i.e., with the use of chemical linkers) as well as electrochemical binding, electrostatic binding, hydrophobic binding and hydrophilic binding. Chemical binding can generate stronger attachment of specific binding substances on a biosensor surface and provide defined orientation and conformation of the surface-bound molecules.

Immobilization of specific binding substances to plastic, epoxy, or high refractive index material can be performed essentially as described for immobilization to glass. However, the acid wash step can be eliminated where such a treatment would damage the material to which the specific binding substances are immobilized.

### Methods of Using Biosensors

One embodiment of the invention provides methods of identifying one or more “small molecules” (that is, molecules that are less than about 300 Da) that bind to a target molecule. A target molecule can be, for example, a nucleic acid molecule, a polypeptide, a protein, an antigen, a polyclonal antibody, a monoclonal antibody, a single chain antibody (scFv), F(ab) fragment, F(ab′)₂ fragment, Fv fragment, small organic molecule, small inorganic molecule, cell, virus, bacteria, or biological sample.

A small molecule can be, for example, a nucleic acid molecule, a polypeptide, an antigen, an antibody fragment, a small organic molecule, or a small inorganic molecule. A small molecule can be less than about 1, 5, 10, 50, 75, 100, 125, 150, 175, 200, 225, 250, 275 or 300 Da. Small molecules can be about 0.1 to about 500 Da, about 1 to about 300 Da, about 1 to about 200 Da, about 1 to about 100 Da, about 1 to about 50 Da, about 1 to about 25 Da, or any range in between about 0.1 to about 500 Da. A plate-based label free methodology with appropriate sensitivity allows for the rapid screening of whole libraries of very small (less than about 300 Da) compounds that bind anywhere on the target molecule. A small molecule library can comprise about 5, 10, 25, 50, 100, 500, 1,000, 5,000, 10,000 or more different small molecules. Alternatively, a small molecule library can comprise only one type of small molecule.

Target molecules can be applied to a first location on a surface of a biosensor. A colorimetric resonant reflectance optical first peak wavelength value (PWV) or refractive index is determined for the first location. A small molecule sample (for example a small molecule library) is applied to the first location. The target molecule and small molecule sample can be incubated for period of time if desired. A second PWV or refractive index for the first location is determined. A first value is calculated, wherein the first value is the difference between the first PWV and the second PWV (or first refractive index and second refractive index). If the second PWV (or refractive index) is shifted as compared to the first PWV, then the small molecule sample bound to the target molecule. Optionally, the first value can be compared to a control test. The control test can comprise applying target molecules to a second location on a surface of a biosensor. These target molecules can be applied to the second location at the same time the first set of target molecules are applied to the first location or at a later time. These target molecules can be the same type of target molecules or different target molecules as the set of target molecules applied to the first location. A third PWV (or refractive index) for the second location is detected. A known target molecule binder is applied to the second location. The target molecules can be incubated for a period of time if desired. A fourth PWV (or refractive index) for the second location is detected. A second value is determined, wherein the second value is the difference between the third PWV (or refractive index) and the fourth PWV (refractive index) of the second location. If the first and second values are the same or similar, then the small molecule sample binds to the target molecule. The first and second values are the same or similar if they are within about 1 nm of each other. Because the label free biosensor method of interrogating the target molecules is not destructive to the target molecules, the target molecules may be treated more than one time to look for differences over time.

The first location and second location on the surface of the biosensor can be an internal surface of a vessel selected from the group consisting of a microtiter well, microtiter plate, test tube, Petri dish, microfluidic channel, and microarray. The small molecule sample and test molecules do not have to comprise detection labels in the assays of the invention; however, they may comprise labels if desired.

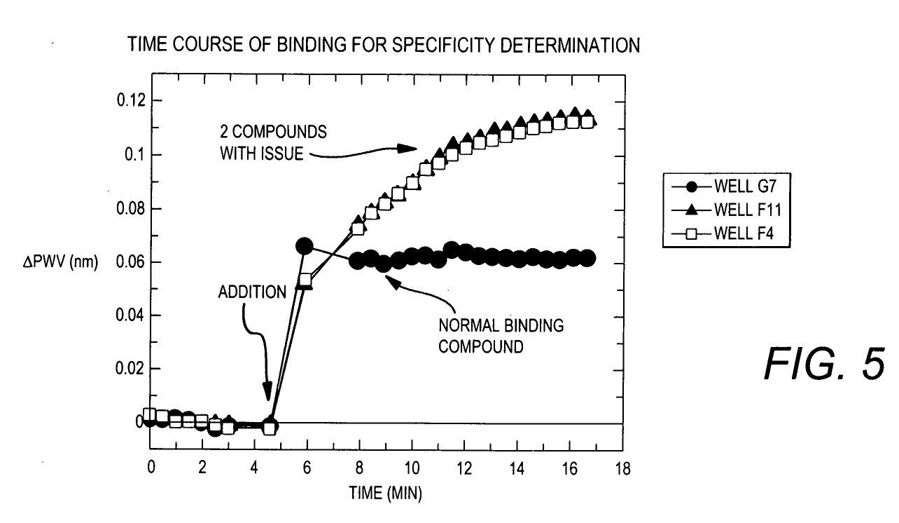

One or more target molecules can be applied to a location, such as a microtiter well on a surface of a biosensor. A receptacle refers to one container and not a collection of containers, e.g., a multiwell plate. A calorimetric resonant reflectance optical peak wavelength value (PWV) (or refractive index) for the location is detected. The one or more target molecules can be incubated for a period of time (e.g., 1 second, 30 seconds, 1, 2, 5, 10, 20, 30, 45 minutes, 1, 2, 5, 10 or more hours). Prior to the incubation, or after the incubation, or prior to the incubation and after the incubation one or more small molecules can be applied to the one or more target molecules. The colorimetric resonant reflectance optical PWV for the location can be detected for a second time. If the one or more of the small molecules bind the target molecules then the reflected wavelength of light is shifted as compared to a situation where no binding occurs. The first PWV can be compared to the second PWV. A change in the PWV can indicate binding. PWVs over several time periods can be determined and compared. Binding can also be monitored in real time (see e.g., FIG. 5).

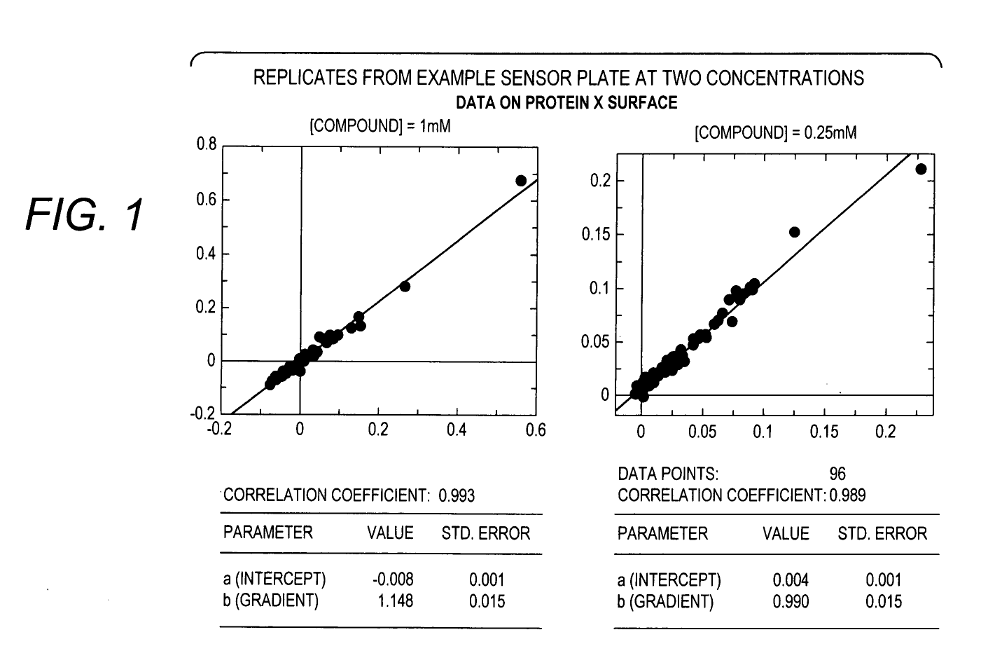

In one embodiment of the invention, the quantity or concentration of small molecules that bind to a target molecule can be determined. See e.g., FIG. 1.

Binding at a biosensor location can be detected via the PWVs of the biosensor surface or monitored more generally using a microscope, digital camera, conventional camera, or other visualization apparatus, magnifying or non-magnifying, that utilizes lens-based optics or electronics-based charge coupled device (CCD) technology.

Preferably, the resolution of the lens of the scanner determining the PWV has an about 2 to about 200, about 2 to about 50, or about 2 to about 15 micrometer pixel size. Assays of the invention can be completed in less than about 1, 5, 10, 15, 30, 45, or 60 minutes. That is, binding can be determined in a time efficient manner.

In developing and designing drugs it is can be advantageous to link a first molecule that binds to a target site on a target molecule to a small molecule that binds to the target site or to an adjacent site on the target molecule. In this way specificity can be added to the first molecule that binds to a target site. For example, many target active sites are quite similar for similar tasked target molecules. However, the target molecule is likely to have sites adjacent to the active site that are unique. The advantage of the adjoined molecule is obtained through the blocking of the target site by one part of the adjoined molecule and through the specificity of binding part of the adjoined molecule to a more unique adjacent target site. Therefore, it can be advantageous to identify small molecules that bind to a target molecule outside of a specific target site. Additionally, because the invention provides a static system capable of determining multiple, sequential interactions it can be used to determine multiple small molecule attachment (at different sites, including different sites within the same target molecule) events.

A target molecule can be “blocked” with a molecule (“a blocker molecule”) that binds to the target molecule (either covalently or non-covalently) at, for example, a target site. A target site can be, for example a site, that if blocked, inactivates or activates the target molecule. Blocked and non-blocked target molecule sensor surfaces can then be probed with a small molecule library to find small molecules from the library that bind the target molecule at the unblocked sites of the target molecule. The methods of the invention also allow for the determination through competition assays of molecules that are interacting/binding to the target at or near the same binding site.

The methods of the invention also allow for the determination of avidity and affinity measurements or equilibrium binding constants through titration assays. Avidity is the combined strength of multiple bond interactions. As such, avidity is the combined synergistic strength of bond affinities rather than the sum of bonds. Affinity means the strength of a single bond. Affinity measurements include, but are not limited to, equilibrium binding constants, dissociation constants, rates of binding and rates of dissociation. The dissociation constant (Kd) is the affinity between a small molecule and a target molecule and therefore denotes how tightly a small molecule binds to a particular target molecule. Affinities can be influenced by, e.g., covalent interactions and non-covalent intermolecular interactions between the two small molecule and target molecule such as hydrogen bonding, electrostatic interactions, hydrophobic and Van der Waals forces. The methods of the invention can detect very weak binding between small molecules and target molecules that are not detectable using other methods. For example, binding between a small molecule and a target molecule can be detected at a Kd of greater than about 2,000, 1,500, 1,000, 750, 500, 250, 100, 50, 25, 10, 5, 1 μM or more. Binding between a small molecule and a target molecule can be detected at a Kd of about 2,000 to about 0.001 μM; about 2,000 to about 0.01 μM; about 2,000 to about 1,000 μM; about 2,000 to about 1,500 μM; about 2,000, to about 750 μM about 1,500 to about 0.01 μM; about 1,000 to about 0.01 μM; about 750 to about 0.01 μM; about 500 to about 0.01 μM; about 250 to about 0.01 μM or any range in between about 2,000 to about 0.001 μM.

In one embodiment, a method of the invention can be used to determine the affinity of small molecules for target molecules. Target molecules can be immobilized to a surface of a colorimetric resonant reflectance biosensor. A first peak wavelength value is determined. Small molecules can be added to the surface of the calorimetric resonant reflectance biosensor at, for example, 3, 5, 10, 12, 15, 24, or 36 or more (or any range between 2 and 1,000) different concentrations. In essence a titration curve is made. A peak wavelength value is detected for each of the different concentrations. The peak wavelengths are compared to determine the affinity of the small molecules for the target molecules. In one embodiment, the molecular weight of the target molecules, or small molecules, or both is known.

Another embodiment of the invention provides a method of determining a rank affinity value of small molecules. A first peak wavelength value of a surface of a calorimetric resonant reflectance biosensor is determined. Target molecules with a known molecular weight are immobilized to the surface of the calorimetric resonant reflectance biosensor. A second peak wavelength value is determined. The amount of moles of the target molecule that bound to the calorimetric resonant reflectance biosensor is determined using the difference between the first and second peak wavelength values. A specific concentration of a small molecule with a known molecular weight is added to the calorimetric resonant reflectance biosensor. A specific molecular weight is not required. For example, an approximate molecular weight value can be used. For example a 300-600 mw range small molecule library can be approximated using 450 Da binding to a 30,000 Da target the variance between 300-600 ratiometrically to the target is negligible. A third peak wavelength value is determined. The difference between the second peak wavelength value and the third peak wavelength value provides the amount of small molecule bound to the calorimetric resonant reflectance biosensor surface. The rank affinity of the small molecules is determined using the ratio of the difference between the second peak wavelength value and the third peak wavelength value to the difference between the first peak wavelength value and the second peak wavelength value.

The invention also provides methods of determining if a small molecule binds to a specific site on a target molecule or competes for target binding with a known blocker of a target site on the target molecule. A target molecule can be immobilized to a first calorimetric resonant reflectance biosensor. The target molecule is also immobilized to a second calorimetric resonant reflectance biosensor, wherein the target site of the target molecule is blocked with a known blocker of the target site. Small molecules are added to both the first and second calorimetric resonant reflectance biosensors and peak wavelength values for the first and second calorimetric resonant reflectance biosensors are determined. If the peak wavelength value of the first calorimetric resonant reflectance biosensor is shifted as compared to the peak wavelength value of the second calorimetric resonant reflectance biosensor, then the small molecule competes with the known blocker of a target site on the target molecule binds or binds to a specific site on the target molecule.

The invention also can determine a stoichiometric ratio of immobilized target molecules to the added small molecules. Furthermore, superstoichiometric interactions can be measured with the invention to determine the specificity of the interaction or “stickiness” of the small molecules. In general, in drug design it is desirable to avoid superstoichiometric or “sticky” small molecules, that is, small molecules that bind to greater than one binding site on the target molecule as they tend to lack the specificity for a particular target and ultimately lead to undesirable toxicities. In one example the amount of target molecule immobilized to the sensor is quantified over time. For example PWVs are taken at 0.1 minute to 1 hour (or any range in between). Two, 5, 10, 20, 30, 50, 100, 200, or more (or any range in between) time points can be taken. Using the fact that one form of the instant invention provides a PWV shift of ˜2 ng/mm², and having the value for the molecular weight of the immobilized target, one can calculate the number of moles of the target that are immobilized on the sensor (2 ng/mm² times size of sensor read area in mm² times 1 mole/mw of the target). This value is used to calculate a corresponding amount of small molecule that will bind the target using the following equation: target immobilization PWV shift times (mw of ligand/mw of target). Using the instant invention and obtaining PWV shift values above this number is indicative of superstoichiometric binding. Where values are a factor of 2-5 times this value is likely to be actual binding to the target. Where values are factors greater than this could be indicative of aggregating compounds. See e.g., FIG. 5.

Typically, when dissociation constants are determined between molecules and target molecules, it is desirable to have the concentration of the molecule that is to bind to the target molecule at about 10 times greater than the expected Kd. However, it can be difficult to screen small molecules at such a high concentration due to the intrinsic solubility of the molecule in reduced amounts of non-aqueous solvent such as one might use with sensitive biological systems. The instant invention provides methods of determining the affinity of small molecules and target molecules at lower concentrations of small molecules (for example about 2 mM, about 1 mM, about 0.5 mM, about 0.25 mM, or about 2 mM to about 0.5 mM, about 2 mM to about 0.25 mM, about 0.5 mM to about 0.01 mM or any range between 2 mM and 0.01 mM). At concentrations of the small molecule below the Kd, the binding signal for most assays will be significantly diminished if at all detectable. The binding signal will rise as the concentration increases to the point where it is one half maximal at a concentration point equal to the Kd. Because the instant invention allows for the prediction of the maximal signal (see above), any lower concentration of small molecule that begins to give binding signal starts a sloped line that leads to the predicted plateau. One practiced in the art will recognize that an affinity of the small molecule for the target can be ascertained from said slope and said maximal signal.

The methods of the invention can also be used to determine the reduction of biologic activity through the displacement of known binding partners in an inhibition type assay. Both the known binding partner and one or more small molecules are added to a biosensor surface that has blocked or unblocked target sites. Control assays include adding only the one or more small molecules, only the known binding partner, or no molecules to the blocked and unblocked surfaces.

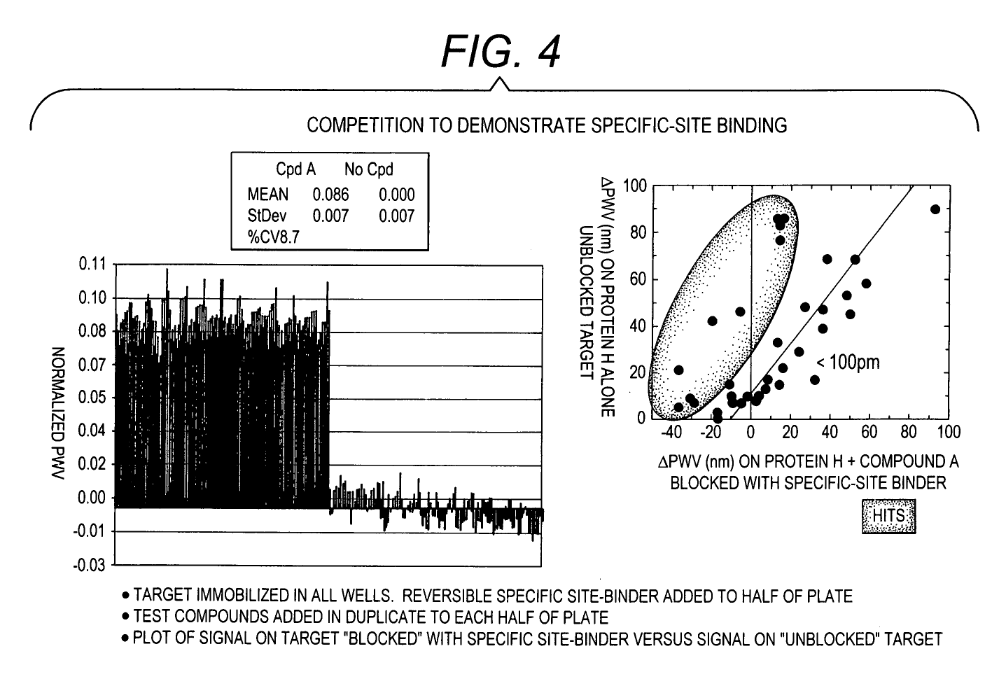

Methods of the invention can also identify and correct for the variance that may occur between testing blocked (with a known binder to the target molecule) and non-blocked target molecules. For example, if a known tight binding molecule is added to a target molecule coated biosensor surface and then a library of small molecule (in DMSO buffer or a salt buffer) is added to the surface a signal can then be detected. The signal may represent binding. Alternatively, the signal can represent a false signal due to salt buffers or DMSO buffers. For example, DMSO in a small molecule library solution can cause a variation as high as 25% or higher in the signal. One embodiment of the invention provides for the “mismatch” correction by titration of the DMSO on target site blocked and non-blocked biosensor surfaces. A target site blocked surface is a surface where a target molecule is immobilized to the biosensor surface and a molecule known to bind to the target site of the molecule (i.e., a “blocker molecule”) is added to the biosensor surface. An unblocked surface is a surface where the target molecule is immobilized to the biosensor surface. One or more types of small molecules are added to the blocked and unblocked surfaces. If a negative PWV shift is observed on the blocked biosensor surface, then the DMSO or salt buffer is causing a variation. If a positive shift is seen on both the blocked surface and on the unblocked surfaces then the small molecule is binding to the target at a site other than the known binding molecule. If a positive shift is seen on the unblocked surface and a lesser positive shift is seen on the blocked surface, then the known binding molecule and the small molecule are binding to the same target site. See e.g., FIG. 4. To correct for the variation caused by DMSO or salt buffers, the negative shift in PWV measured on the reference or control surface can be added to the binding signal of the target surface.

Examples of types of interactions the methods of the invention can detected are shown in Table 1.

TABLE 1

| Specific Interaction | Other Interactions |
|---|---|
| Stoichiometry 1:1 | Superstoichiometric |
| Good fit of dose response | Poor fit of dose response |
| curves to binding isotherm | curves to binding isotherms |
| Competitive discrimination | Same signal with competitor |
| Binding at mixing rate | Slower time course |

All patents, patent applications, and other scientific or technical writings referred to anywhere herein are incorporated by reference in their entirety. The invention illustratively described herein suitably can be practiced in the absence of any element or elements, limitation or limitations that are not specifically disclosed herein. Thus, for example, in each instance herein any of the terms “comprising”, “consisting essentially of”, and “consisting of” may be replaced with either of the other two terms, while retaining their ordinary meanings. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by embodiments, optional features, modification and variation of the concepts herein disclosed may be resorted to by those skilled in the art, and that such modifications and variations are considered to be within the scope of this invention as defined by the description and the appended claims. In addition, where features or aspects of the invention are described in terms of Markush groups or other grouping of alternatives, those skilled in the art will recognize that the invention is also thereby described in terms of any individual member or subgroup of members of the Markush group or other group.

### EXAMPLES

A target molecule, Protein X (26 kDa), having an ATP-ase domain, was immobilized to a colorimetric resonant reflectance biosensor. A compound library having an average MW of library members of <300 Da was added to the biosensor. Direct binding of the library constituents to the biosensor was detected. Binding data for the compound library was also obtained from biophysical methods, including NMR and X-ray crystallography.

About 500 molecules in 2% DMSO buffer were screened. The read time was less than 10 minutes. The ligand screen concentrations were 250 μM and 1 mM. The results showed: a dynamic range for 200 Da ligand with 1:1 stoichiometry, full binding 60 pm, S/N=12; proper identification of positive and negative controls; a range of affinities detected/titrated 1 nM to ˜1 mM; and strong hit correlation with lower throughput biophysical methods.

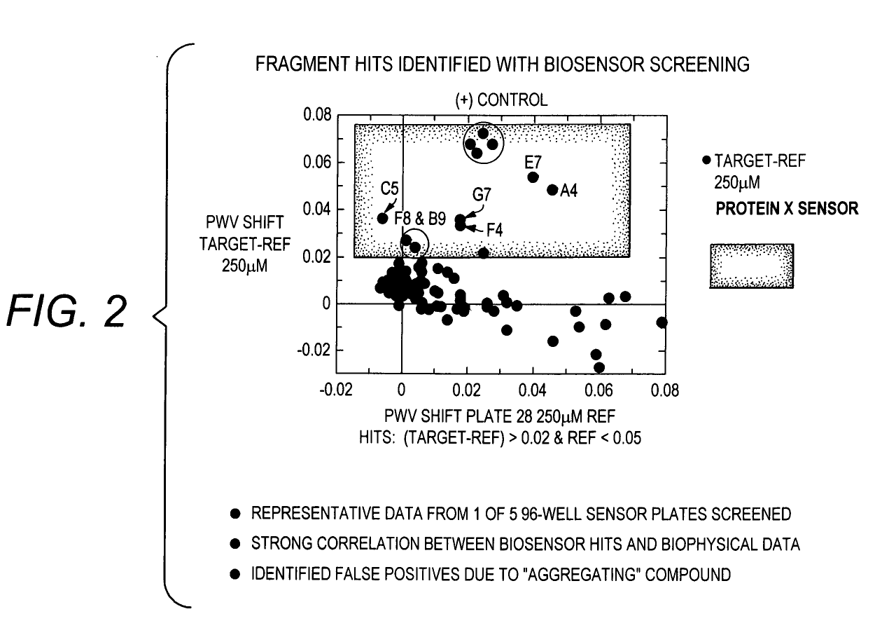

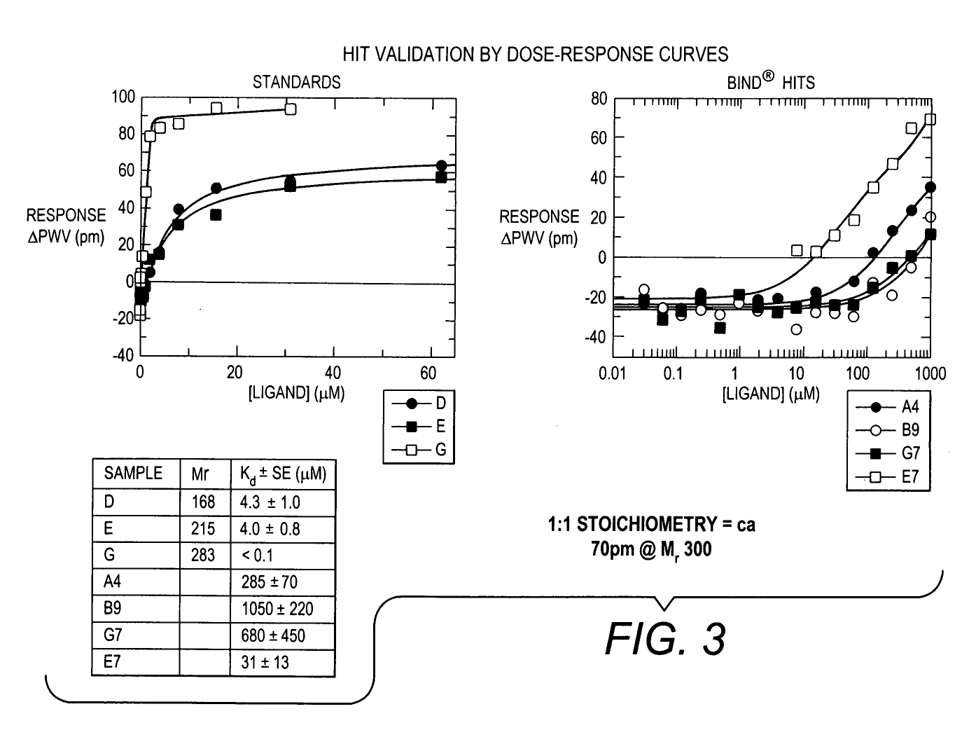

The following compounds were identified (see FIGS. 2 and 3):

Fragment A: (Mr=265 Da, Kd˜0.01 uM)

Fragment B: (Mr=263 Da, Kd˜1 uM)

Fragment C: (Mr=249 Da, Kd˜1 uM)

Fragment D: (Mr=168 Da, Kd˜100 uM)

Fragment E: (Mr=215 Da, Kd˜10 uM)

Fragment F: (Mr=265 Da, Kd ˜0.1 uM)

Fragment G: (Mr=283 Da, Kd˜0.001 uM)

FIG. 1 shows the reproducibility of the biosensor for sensitive detection of weakly associating small molecules to Protein X, which was immobilized on the surface of the sensor. The small molecule was added to the surface of the sensor plate at a concentration of 1 mM or 0.25 mM. The results demonstrate highly reproducible, quantitative results. The assays were performed in standard 96 and 384 well plates.

FIG. 2 shows aggregating compounds and DMSO mismatch compounds provide a significantly different signal on the control or blocked surface (x-axis) as compared to the target surface (y-axis) when added in equal concentrations to both. The figure highlights, in a circled area, the positive control (known binding) compounds used to obtain statistical evaluation of the robustness of the assay. The assay identified false positives due to aggregating molecules (those outside of the shaded box). The assay confirmed, with a strong correlation, binding compounds as determined by other biophysical assays: nuclear magnetic resonance spectroscopy, x-ray crystallography, and isothermal titrating calorimetry. FIG. 2 shows representative data from 1 of 5 96-well sensor plates.

FIG. 3 the “Standards” graph shows that the methods of the invention can be used to titrate and obtain reasonable affinity binding curves for known binding compounds obtained by other biophysical methods. The “BIND® Hits” graph shows that the compounds that are “discovered” by the methods of this invention can be confirmed as binding compounds by further biochemical characterization by the methods of this invention by performing titration curves that are fit to equilibrium binding constants for the ranking of affinity. Therefore, methods of this invention can be used to determine how tight each binding compound binds to the target molecule, to determine stoichiometry, and to determine individual binding sites using, e.g., competition assays.

FIG. 4 demonstrates methods of this invention enable the determination of binding of weakly associating fragments to different binding sites. Compounds that give signals that are greater than zero and are equal to a rough approximation when tested on the target surface and also on the blocked target surface have no specificity for the target and are less likely to be actually binding to a single site on the target. The compounds in the highlighted, circled, region are showing a significantly larger signal on the target than they are showing on the blocked target surface, hence, they are determined to be binding specifically and in a proper ratio as determined from the molar calculations provided by the PWV shift signal.

FIG. 5 shows a time course assay of binding for specificity determination. Slower binding can represent less specificity especially when the PWV shift goes above 1:1 stoichiometry. Compounds well F11 and well F4 represent “sticky” or superstoichiometric compounds. Normal 1:1 binding demonstrates a stable plateau signal that occurs within mixing time, (compound well G7).

We claim:

1. A method of determining the affinity of small molecules for target molecules, wherein the method comprises:
(a) immobilizing the target molecules to a surface of a calorimetric resonant reflectance biosensor and determining a first peak wavelength value;
(b) adding the small molecules to the surface of the calorimetric resonant reflectance biosensor at 3 or more different concentrations and determining a peak wavelength values at the 3 or more different concentrations;
comparing the peak wavelengths to determine the affinity of the small molecules for the target molecules.

2. The method of claim 1, wherein the small molecules are less than about 300 Da.

3. The method of claim 1, wherein the dissociation constant (Kd) of the small molecules is determined.

4. The method of claim 3, wherein the dissociation constant of the small molecules is about 2,000, to about 750 μM.

5. The method of claim 1, wherein the concentration of the small molecules is about 0.5 mM to about 0.01 mM.

6. A method of determining a rank affinity of a small molecule sample comprising:
(a) detecting a first peak wavelength value of a surface of a colorimetric resonant reflectance biosensor;
(b) immobilizing target molecules with a known molecular weight to the surface of the colorimetric resonant reflectance biosensor and determining a second peak wavelength value;
(c) determining the amount of moles of the target molecule is bound to the calorimetric resonant reflectance biosensor using the first and second peak wavelength values;
(d) adding a specific concentration of a small molecule sample with a known molecular weight to the calorimetric resonant reflectance biosensor and determining a third peak wavelength value; wherein the difference between the second peak wavelength value and the third peak wavelength value provides the amount of small molecule bound to the calorimetric resonant reflectance biosensor surface; and
(e) determining the rank affinity of the small molecule sample using ratio of the difference between the first peak wavelength value and the second peak wavelength value to the difference between the second peak wavelength value and the third peak wavelength value.

7. The method of claim 6, wherein the small molecule sample comprises small molecules that are less than about 300 Da.

8. The method of claim 6, wherein the dissociation constant of the small molecules in the small molecule sample is about 2,000, to about 750 μM.

9. The method of claim 6, wherein the concentration of the small molecules in the small molecule sample is about 0.5 mM to about 0.01 mM.

10. A method of determining if small molecules bind to a specific site on a target molecule or compete for target binding with a known blocker of a target site on the target molecule comprising:
(a) immobilizing the target molecule to a first calorimetric resonant reflectance biosensor;
(b) immobilizing the target molecule to a second calorimetric resonant reflectance biosensor, wherein the target site of the target molecule is blocked with a known blocker of the target site;
(c) adding small molecules to both the first and second colorimetric resonant reflectance biosensors and determining peak wavelength values for the first and second calorimetric resonant reflectance biosensors;
wherein, if the peak wavelength value of the first calorimetric resonant reflectance biosensor is shifted as compared to the peak wavelength value of the second calorimetric resonant reflectance biosensor, then the small molecules compete with the known blocker of a target site on the target molecule or binds to a specific site on the target molecule.

11. The method of claim 10, wherein the small molecules are less than about 300 Da.

12. The method of claim 10, wherein the dissociation constant of the small molecules is about 2,000, to about 750 μM.

13. The method of claim 10, wherein the concentration of the small molecules is about 0.5 mM to about 0.01 mM.

14. A method of determining if small molecules of less than 300 Da bind to target molecules, wherein the method comprises:
(a) immobilizing the target molecules to a surface of a calorimetric resonant reflectance biosensor and determining a first peak wavelength value;
(b) adding the small molecules to the surface of the calorimetric resonant reflectance biosensor and determining a second peak wavelength value;
comparing the first and second peak wavelengths, wherein if the second peak wavelength value is shifted as compared to the first peak wavelength value, then the small molecules bind the target molecules.

15. The method of claim 14, wherein the dissociation constant (Kd) of the small molecules is determined.

16. The method of claim 15, wherein the dissociation constant of the small molecules is about 2,000, to about 750 μM.

17. The method of claim 14, wherein the concentration of the small molecules is about 0.5 mM to about 0.01 mM.
